(19) United States
(12) Patent Application Publication
(10) Pub. No.: US 2014/0358805 A1
(43) Pub. Date: Dec. 4, 2014

(54) Illegal Activity Detection through Interpersonal Relationship Resolution

(71) Applicant: International Business Machines Corporation, Armonk, NY (US)

(72) Inventors: Karl J. Cama, Coppell, TX (US); Norbert Herman, Denver, CO (US); Daniel T. Lambert, New York, NY (US)

(73) Assignee: International Business Machines Corporation, Armonk, NY (US)

(21) Appl. No.: 14/089,859

(22) Filed: Nov. 26, 2013

Related U.S. Application Data
(63) Continuation of application No. 13/909,276, filed on Jun. 4, 2013.

(51) Int. Cl. G06Q 50/26; G06Q 10/00

(52) U.S. Cl. CPC G06Q 50/26; G06Q 10/00
USPC 705/319

(57) ABSTRACT

The detection of illegal activity through interpersonal relationship resolution. A method in accordance with an embodiment includes: assigning a risk assessment score to a person of interest; identifying and mapping at least one first line connection of the person of interest; assigning a risk assessment score to each first line connection; updating the risk assessment score assigned to the person of interest based on the risk assessment score assigned to each first line connection; comparing the risk assessment score of the person of interest to at least one threshold value; and detecting an illegal activity based on the comparing.

### REFERENCE TO PRIOR APPLICATIONS

The current application is a continuation application of U.S. Utility application Ser. No. 13/909,276, which was filed on 4 Jun. 2013.

### TECHNICAL FIELD

The present invention relates generally to data analysis, and more particularly, to the detection of illegal activity (e.g., fraudulent, terrorist, or criminal activity) through interpersonal relationship resolution.

### RELATED ART

Many companies and businesses (e.g., insurance companies, banks, etc.), local and national security agencies (e.g., Federal Bureau of Investigation (FBI), Central Intelligence Agency (CIA), etc.), and other law enforcement organizations use social media and telecommunication data records to investigate fraud, terrorism, and other types of criminal activity. For example, a disability insurance claim may be rejected by examining a person's social media profile and determining that the person is actually healthy. In the case of terrorism, such as the bombing during the Boston marathon, social media and telecommunication data records may be used to determine possible motives for an act of terrorism, to identify possible accomplices of a terrorist, or to determine whether a terrorist belongs to organizations that promote violence.

Many techniques have been used to examine a person's social media and telecommunication data records. However, such techniques are not effective in detecting joint crimes in which multiple participants have worked or are working together in the planning and/or execution of a crime or terrorist attack. A typical scenario involves insider trading. In such a scenario, a person who has information regarding an event that may affect the value of a company's stock may ask multiple friends and relatives to participate in an insider trading scheme to avoid filters that look for large transactions before the event occurs. A large long position before a merger, for example, typically raises red flags for investigators. However, detecting multiple smaller transactions before and/or after the merger may be more difficult, especially if those parties are seemingly unrelated. A similar issue may arise in terrorist networks in which multiple parties each play a small part in a terrorist attack.

### SUMMARY

A first aspect of the invention provides a computer-implemented method of detecting illegal activity through interpersonal relationship resolution, the method including: assigning a risk assessment score to a person of interest;

identifying and mapping at least one first line connection of the person of interest; assigning a risk assessment score to each first line connection; updating the risk assessment score assigned to the person of interest based on the risk assessment score assigned to each first line connection; comparing the risk assessment score of the person of interest to at least one threshold value; and
detecting an illegal activity based on the comparing.

A second aspect of the invention provides a computer system including: a set of computing devices for detecting illegal activity through interpersonal relationship resolution by performing a method including: assigning a risk assessment score to a person of interest; identifying and mapping at least one first line connection of the person of interest; assigning a risk assessment score to each first line connection; updating the risk assessment score assigned to the person of interest based on the risk assessment score assigned to each first line connection; comparing the risk assessment score of the person of interest to at least one threshold value; and detecting an illegal activity based on the comparing.

A third aspect of the invention provides a computer program product including program code embodied in at least one computer-readable storage medium, which when executed, enables a computer system to implement a method of detecting illegal activity through interpersonal relationship resolution, the method including: assigning a risk assessment score to a person of interest; identifying and mapping at least one first line connection of the person of interest; assigning a risk assessment score to each first line connection; updating the risk assessment score assigned to the person of interest based on the risk assessment score assigned to each first line connection; comparing the risk assessment score of the person of interest to at least one threshold value; and detecting an illegal activity based on the comparing.

Other aspects of the invention provide methods, systems, program products, and methods of using and generating each, which include and/or implement some or all of the actions described herein. The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1 shows an illustrative hub and spoke model for detecting illegal activity through interpersonal relationship resolution according to an embodiment.

FIGS. 2 and 3 show an illustrative implementation of the model of FIG. 1 for detecting insider trading according to an embodiment.

FIG. 4 shows a many-to-many database table according to an embodiment.

FIGS. 5 and 6 show an illustrative implementation of the model of FIG. 1, employing weighting, for detecting insider trading according to an embodiment.

FIG. 7 depicts a flow diagram of an illustrative method for detecting illegal activity through interpersonal relationship resolution according to an embodiment.

FIGS. 8-12 show an illustrative implementation of the model of FIG. 1 for detecting terrorist activity according to an embodiment.

FIG. 13 shown a many-to-many database table according to an embodiment.

FIG. 14 shows an illustrative environment for detecting illegal activity through interpersonal relationship resolution according to an embodiment.

It is noted that the drawings may not be to scale. The drawings are intended to depict only typical aspects of the invention, and therefore should not be considered as limiting the scope of the invention. In the drawings, like numbering represents like elements between the drawings.

### DETAILED DESCRIPTION

The present invention relates generally to data analysis, and more particularly, to the detection of illegal activity (e.g., fraudulent, terrorist, or criminal activity) through interpersonal relationship resolution. As used herein, unless otherwise noted, the term “set” means one or more (i.e., at least one) and the phrase “any solution” means any now known or later developed solution.

In accordance with the present invention, social network data, telecommunications data records, and historical data are used to establish a basis for partnership related criminal activity that has occurred or may occur in the future. Embodiments of the present invention may be used to establish entity relationships of the conspirators in a criminal activity using, for example, an event-triggered hub and spoke type model. The entity relationships may be identified using, for example, one or more of: 1) direct connections (e.g., a Facebook friend); 2) indirect connections (e.g., a Facebook friend of a friend); 3) name similarities that may indicate a familial relationship; 4) messaging (e.g., via Twitter, Skype, or other messaging programs); 5) telephone call records that generate direct and indirect communication links between entities; and 5) location information of entities (e.g., obtained from mobile telephone location data). In certain embodiments, historical data such as email records, IP addresses, web browsing history, purchase history, financial history, and/or the like may also be used to established relationships.

A tremendous amount of data can be mined from the websites of Facebook, Twitter, and other social media sites, using search engines provided via the websites themselves, or using other searching tools such as boardreader, GNIP, etc. Search engines such as Google and/or commercially available or proprietary searching software can also be used. Telecommunication data records, including, for example, data records associated with telephony, mobile telephony, Internet access, Internet email, Internet telephony, etc., may be provided by phone companies, ISPs, and other sources. This data can be used, for example, to: trace, identify, and locate the source and destination of a communication; identify the date, time, duration, and type of communication; identify the communication device; determine the physical location of mobile communication equipment; etc.

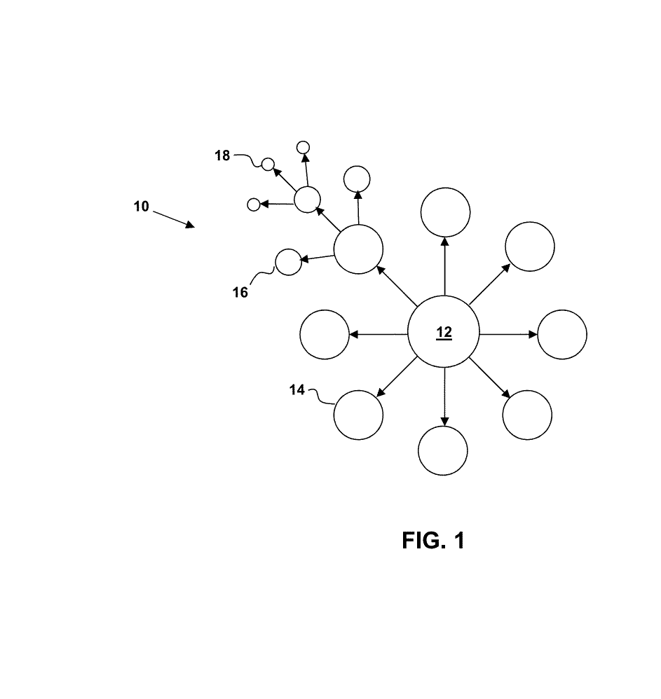

An illustrative event-triggered hub and spoke model 10 is depicted in FIG. 1. The center or hub of the model 10 may be assigned to a person of interest 12 (e.g., a person under investigation, a person on a watch list, a person who has access to information that may lead to insider trading, a person who has made a questionable purchase (e.g., ammonium nitrate) indicating potential criminal or terrorist related activity, etc.). First line connections 14 of the person of interest 12 may then be mapped around the person of interest 12 in response to the detection of an “event.” The first line connections 14 may include those people in direct communication or contact with the person of interest 12. Such direct communication or contact may include, for example, phone calls between the person of interest 12 and a first line connection 14, messages or emails between the person of interest 12 and a first line connection 14, social media contact (e.g., Facebook friends) between the person of interest 12 and a first line connection 14, and visits to the same or similar websites. Other types of direct communication or contact may include, for example, similar mailing or home addresses, similar names, being located near one another at the same time, being related to one another, belonging to the same organizations, making similar or related purchases or financial transactions, and/or the like. Such direct communication or contact is considered to be an event in accordance with embodiments of the present invention.

The same process may then be performed for each of the first line connections 14. For example, people in direct communication or contact with each of the first line connections 14 are determined and are mapped around each first line connection 14 in response to the detection of an event. Such connections are second line connections 16 relative to the person of interest 12. This process can be repeated as desired to determine additional levels of connections, such as the third line connections 18 depicted in FIG. 1. The different levels of connections 14, 16, 18, etc., can be visualized as concentric circles formed around the person of interest 12. The number of connections in each of the different levels as well as the number of levels in the model 10 will vary based on the implementation of the model 10 and are not limited to the example shown in FIG. 1.

The various connections can be weighted to indicate, for example, the relative importance, risk, probability, strength, etc. of each connection or the type of event that connects them. The particular form of the weighting may vary depending on the specific application of the present invention. For example, in the case of a terrorist network, a direct communication or contact between the person of interest 12 and a first line connection 14 may increase the risk assessment score of the person of interest 12 more than a direct communication or contact between a second and third line connection 16, 18. Further, again in the case of a terrorist network, a determination of the collocation of the person of interest 12 and a first line connection 14 using telecommunication data records or real time telecommunication data may increase the risk assessment score of the person of interest 12 more than an email communication between the two parties. These examples are merely illustrative of the type of weighting that can be used and are not intended to be limiting.

Compounded weighting can be used to indicate that particular combinations of connections may be given a higher weight that other combinations of connections. For example, connections based on a telephone call and relative proximity may be weighted higher than connections based on a tweet and a common website visit. Once again, the particular form of any compounded weighting may vary depending on the specific application of the present invention.

The model 10 can be used to establish a basis for partnership related criminal activity that has occurred or may occur in the future. The model 10 can be used to investigate entity relationships and to detect some or all of the entities involved in the criminal activity (e.g., person of interest 12, first line connections 14, second line connections 16, third line connections 18, . . . ). In embodiments, a time variable may be used to limit the time window during which entity relationships are determined and examined. For example, the model 10 may be used to determine entity relationships that existed one week, one month, etc., before and/or after the occurrence of the criminal activity. Repeated entity interactions within a given time window may also indicate a higher likelihood of criminal behavior. The time variable may also be used to identify people that have been near each other during a given time window (i.e., same time, same place).

The model 10 can be provided, for example, using IBM's SPSS predictive analytics software, weighting of relationship distances, a series of SQL queries, heuristic algorithms, Bayesian statistical models, neural networks, or more advanced mathematical models such as k-NN (k-nearest neighbor algorithms). Other methodologies such as may also be used to develop the model 10.

An example of how the model 10 can be used to establish a basis for insider trading will now be described.

In this example, a company has announced unsatisfactory quarterly earnings, which caused the price of the company's stock to decrease dramatically. A number of employees of the company were aware of the unsatisfactory quarterly earnings before this information was made public. A number of investors shorted the stock before the quarterly earnings were announced to the public. A list of each group of people is generated: group X—employees with insider information; and group Y—investors.

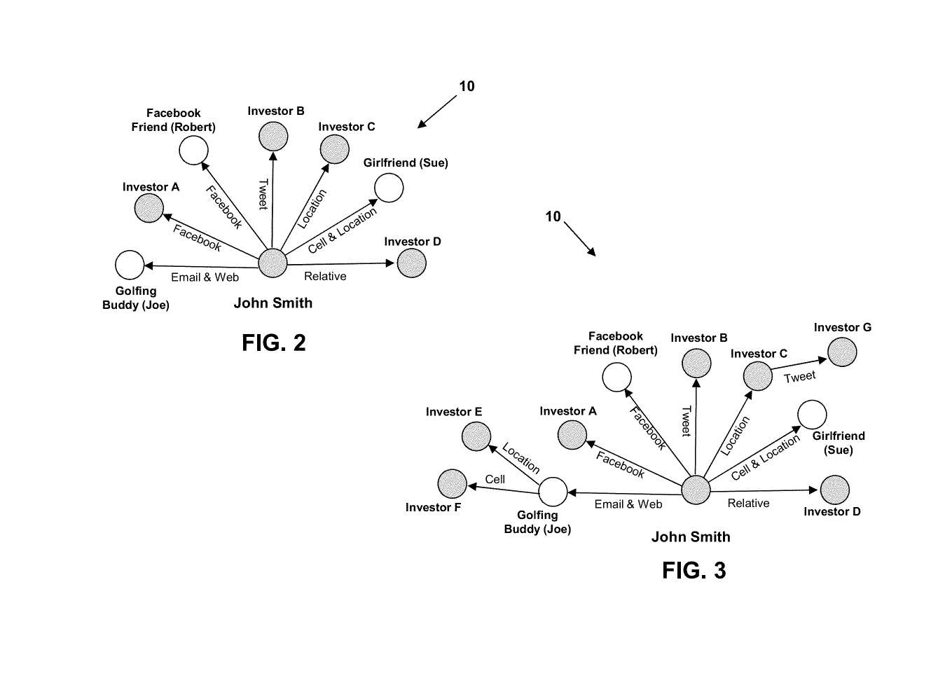

A model 10 for each employee in group A is generated. In this example, as depicted in FIG. 2, a model 10 is generated for a person of interest, employee “John Smith.” First line connections of John Smith are determined and cross-referenced against the investors in group Y that shorted the stock during a time period (e.g., 1-12 hours) prior the announcement of the quarterly earnings to the public. Four investors, “Investor A,” “Investor B,” “Investor C,” and “Investor D,” who are each first line (i.e., direct) connections to John Smith, shorted small amounts of the stock as indicated by the shaded circles, and promised John Smith a portion of the proceeds from the investment.

Investor A is determined to be a Facebook friend of John Smith. Investor B received a tweet from John Smith a few hours before the announcement. Based on telecommunication data records, it is determined that Investor C met with John Smith for dinner the night before the announcement. Investor D is a relative of John Smith.

Other first line connections of John Smith did not short the stock. These first line connections include a golfing buddy “Joe” who frequently emails John Smith and who frequents the same golfing forum on the Internet, and John Smith's girlfriend “Sue” who frequently calls John Smith via cell phone and is often collocated with John Smith. A Facebook friend “Robert” also did not short the stock.

This process is then repeated for each of the first line connections. In particular, people in direct communication or contact with each of the first line connections are determined and are mapped around each first line connection as depicted in FIG. 3. Such connections are second line connections relative to John Smith. For clarity, not all of the second line connections are depicted in FIG. 3.

The second line connections in FIG. 3 include “Investor E” and “Investor F,” who are in direct communication or contact with Joe, John Smith's golfing buddy. Investor E was informed about the quarterly report while golfing with Joe, while Investor F was informed by Joe via cell phone. Investor C tweeted “Investor G.” Each of these investors also promised John Smith a portion of the proceeds from the investment.

The process can be repeated as desired to determine additional lines of connection to John Smith and any associated insider trading collusion. As can be seen from FIG. 3, while John Smith did not directly short the stock, many acquaintances of John Smith did short the stock as indicated by the shaded circles. This information indicates that it is highly likely that John Smith and some of his associates may be guilty of security fraud.

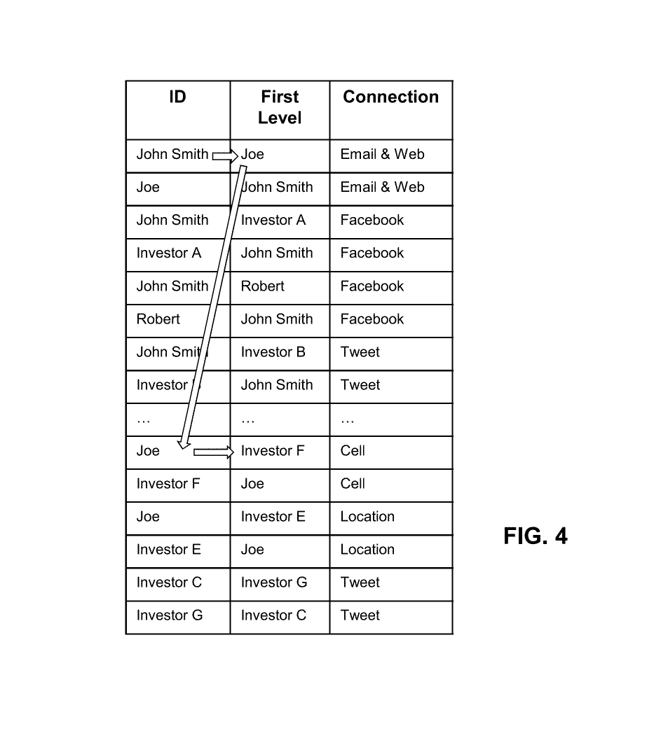

The data regarding each first line (direct) connection in this example may be stored to a many-to-many database table. An example of such a many-to-many database table is shown in FIG. 4. The many-to-many database table may be converted into a multi-dimensional array of data (e.g., a data cube) to determine second, third, and additional lines of connections for John Smith and any other person listed in the model. An example of how the data in the many-to-many database table in FIG. 4 can be used to determine that a person such as Investor F is a second line connection to Joe Smith is indicated by the flow of arrows in FIG. 4.

The example depicted in FIGS. 2 and 3 was directed to the detection of security fraud after the fact. The present invention, however, can also be used to proactively predict security fraud before it occurs. Using IBM's SPSS predictive modeling capabilities, for example, it is possible to actively ‘listen’ for patterns indicating security fraud or other criminal or terrorist activities as they emerge in the model. This may be accomplished, for example, by monitoring the social network data, telecommunications data records, and historical data of John Smith and his various connections (e.g., direct, second line, third line, etc.) and cross-referencing this information against pending orders of investors prior (e.g., 1-3 hours) to the announcement of the quarterly earnings. This information can then be modeled in a manner similar to that shown in FIGS. 2 and 3, to indicate who is likely to be involved in the scheme.

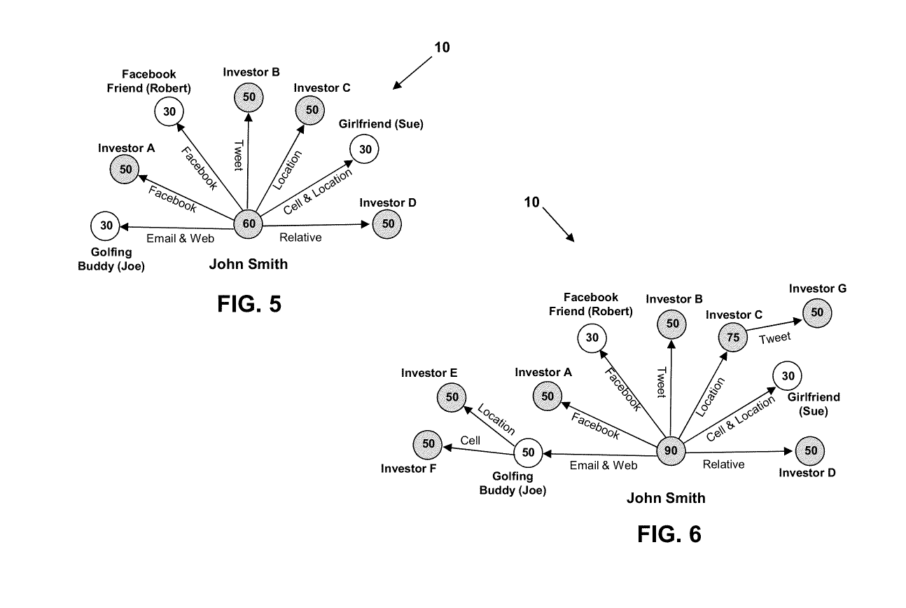

The model 10 of the present invention may also provide data regarding the likelihood or risk that criminal activity has occurred or will occur. An example of this is depicted in FIGS. 5 and 6.

Because John Smith is aware of information that could possibly be used for insider trading, he is initially assigned a risk assessment score of, for example, 20 out of 100. However, his risk assessment score is increased by 10 for each of his direct (first line) connections that shorted (or planed to short) the stock based on John Smith's insider information. To this extent, as shown in FIG. 5, John Smith's risk assessment score has now increased from 20 to 60. Each investor (Investor A-D), who is directly connected to John Smith and who shorted (or planed to short) the stock based on John Smith's insider information, is assigned a risk assessment score of 50. Any remaining direct connections that may have received, but not acted on, the insider information provided by John Smith are assigned a risk assessment score of 30.

As shown in FIG. 6, John Smith's risk assessment score is increased by 10 for each second line connection investor (e.g., Investors E, F, and G) that shorted (or planed to short) the stock based on information provided by one of John Smith's direct connections. Thus, John Smith's risk assessment score has now increased from 60 to 90. Investors E and F are assigned a risk assessment score of 50, while Joe's risk assessment score has increased from 30 to 50 because, even though Joe did not participate directly in any stock purchase, he provided insider information to Investors E and F. Investor G is assigned a risk assessment score of 50, while Investor C's risk assessment score has increased from 50 to 75, because Investor C passed insider information to Investor G.

When the assigned risk assessment score of any person represented in the model 10 reaches a predetermined threshold, a notification indicating that insider trading may have occurred or may be occurring may be communicated to one or more recipients. The notification may include, for example, an email, tweet, phone call, letter and/or the like sent to a predetermined set (one or more) of recipients, a posting to website, and/or the like. The notification may be sent after the fact to identify those persons who may have been involved in insider trading, or may be sent before the event occurs to prevent the insider trading from occurring.

The predetermined threshold is application specific and may be set to any desired value. For instance, assuming a threshold of ≧50 in the above example, notifications identifying John Smith and Investors A-G as possibly being involved in insider trading will automatically be sent to a predetermined set of recipients. Multiple predetermined thresholds may also be used to identify different levels of insider trading activity. For example, in addition to the threshold of ≧50, a second threshold of ≧75 may be used to determine a higher level of involvement is the insider trading.

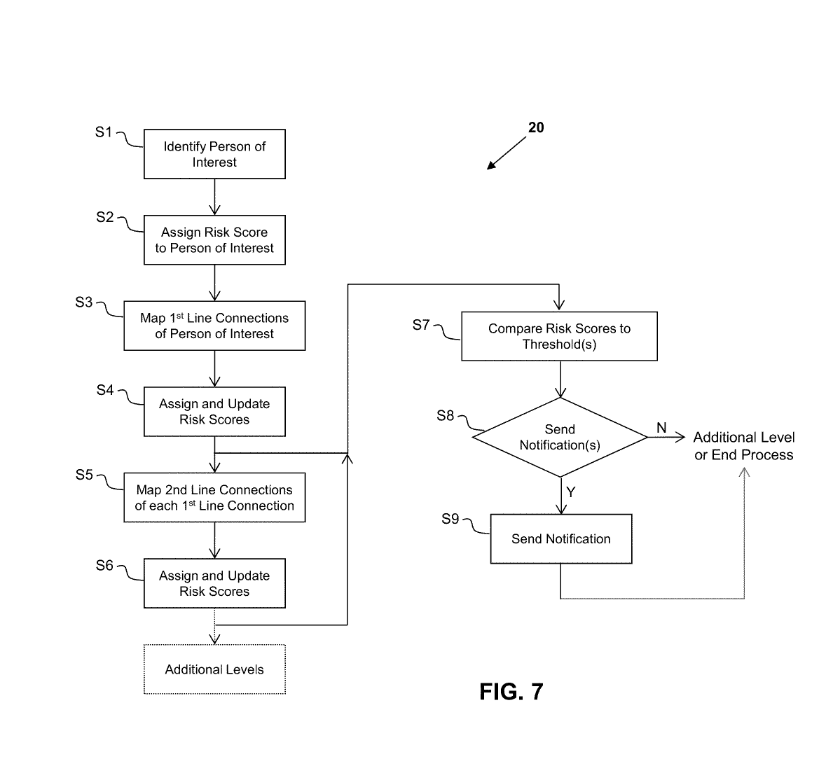

FIG. 7 depicts a flow diagram of an illustrative method 20 for detecting illegal activity through interpersonal relationship resolution according to an embodiment.

At S1, a person of interest is identified. At S2, a risk assessment score is assigned to the person of interest.

At S3, the first line connections of the person of interest are identified and mapped to the person of interest, and a subset (one or more) of the first line connections involved in an activity of interest (e.g., shorted stock as in the example above), who are on a watch list, who have a criminal record, and/or the like, are identified. At S4, a risk assessment score is assigned to each first line connection and the risk assessment score assigned to the person of interest is updated based on the risk assessment scores assigned to each first line connection. At S5, the second line connections of the person of interest are mapped to each first line connection, and a subset (one or more) of the second line connections are identified. At S6, a risk assessment score is assigned to each second line connection and the risk assessment scores of each first line connection and the person of interest are updated accordingly. This process may be repeated for additional lines of connections, if desired.

Each time the risk assessment scores are assigned and updated, flow passes to S7, where the risk assessment scores in the model are compared to one or more threshold values. If notification is required (Yes at S8), one or more notifications are communicated at S9. Thereafter, the process ends or another level is generated in the model. If notification is not required (No at S8), the process then ends or another level is generated in the model.

Another illustrative use of the present invention is described below. In this example, the person of interest is a terrorist, given the ID “Terrorist A.” Terrorist A may be listed on one or more terrorist watch lists and has therefore been assigned a risk assessment score of 50. Other terrorists, for example, “Terrorist B” and “Terrorist C,” may also be listed on one or more terrorist watch lists. Terrorists B and C have been assigned risk assessment scores of 30 and 40, respectively.

A terrorist watch list may include persons having a criminal record for terrorist-related activities or known associations with terrorists or terrorist organizations. Active membership in some extremist groups may get a person a spot on a terrorist watch list. Persons involved in activities such as car-jacking, large transfers of money, etc., may also be placed on a terrorist watch list. Having the same or similar name may also result in membership on a terrorist watch list. If a person's name matches a name on a terrorist watch list, that person will likely be flagged for activities regulated by the federal government, such as air travel, border crossings, etc. As will be described in greater detail below, the present invention can be used, for example, to place people on one or more terrorist watch lists or can be used to augment/update one or more existing terrorist watch lists.

Location information for the three terrorists, Terrorist A, Terrorist B, and Terrorist C, has been determined based on location area data provided in the telecommunication data records associated with the terrorists' cell phones. The location area data may be provided by a telecommunication company in many different formats including, for example, sector numbers or identifiers, signal strength information, vector type information, etc. The location area data can be translated into a physical location in a manner known in the art. In the following description, the location area data comprises sector information.

The sector information is gathered and stored for each incoming and outgoing phone call, email, text message, and/or the like. Depending on the type of cell phone and its capabilities, as well as the technology employed by the cell phones (e.g., 4g), it may also be possible to accumulate the cell phone sector information in real time, even when a cell phone is not being used to place/receive a phone call. Cell phone sector information may still be accumulated when cell phone is transmitting data, such as downloading or uploading a file), running a background process with data request(s), receiving an SMS, etc. The sector information can be translated into a physical location in a manner known in the art based on the number of sectors.

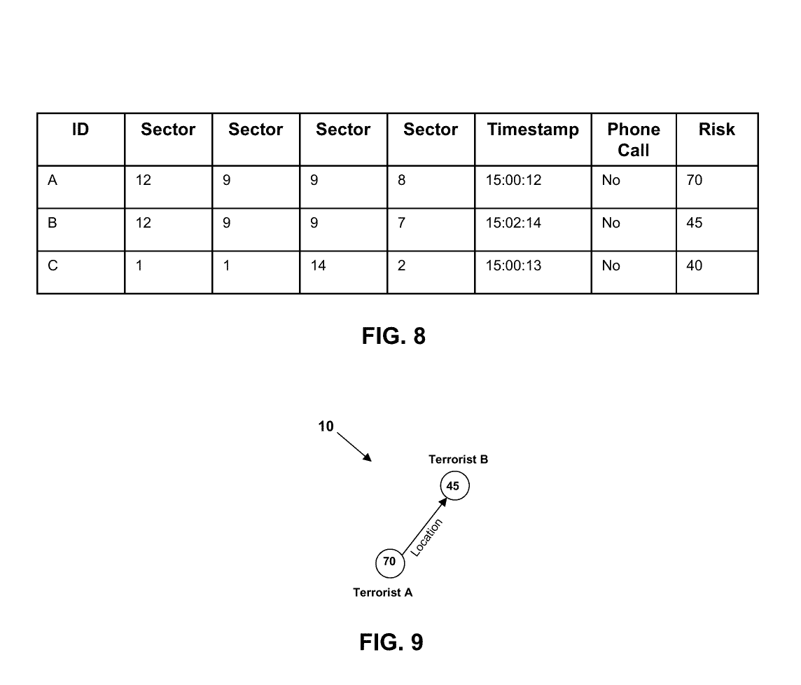

As depicted in FIG. 8, the cell phone used by Terrorist A was detected in sectors 12, 9, 9, and 8 of four cell towers at a time 15:00:12. Terrorist B was detected in sectors 12, 9, 9, and 7 of the same cell towers at a time 15:02:14. Terrorist C was detected in sectors 1, 1, 14, and 2 of the same cell towers at a time 15:00:13. Based on this sector information, Terrorist A was found to be collocated with Terrorist B (e.g. within 700 feet of each other). To this extent, Terrorist B can be considered to be a first line connection (i.e., a direction connection) to Terrorist A, based on common location. Because of the location overlap (due to the sectors coinciding at substantially the same time) the risk assessment score of Terrorist A has increased from 50 to 70, while the risk assessment score of Terrorist B has increased from 30 to 45. The risk assessment of Terrorist C has not changed. A model 10 illustrating the connection between Terrorists A and B is shown in FIG. 9.

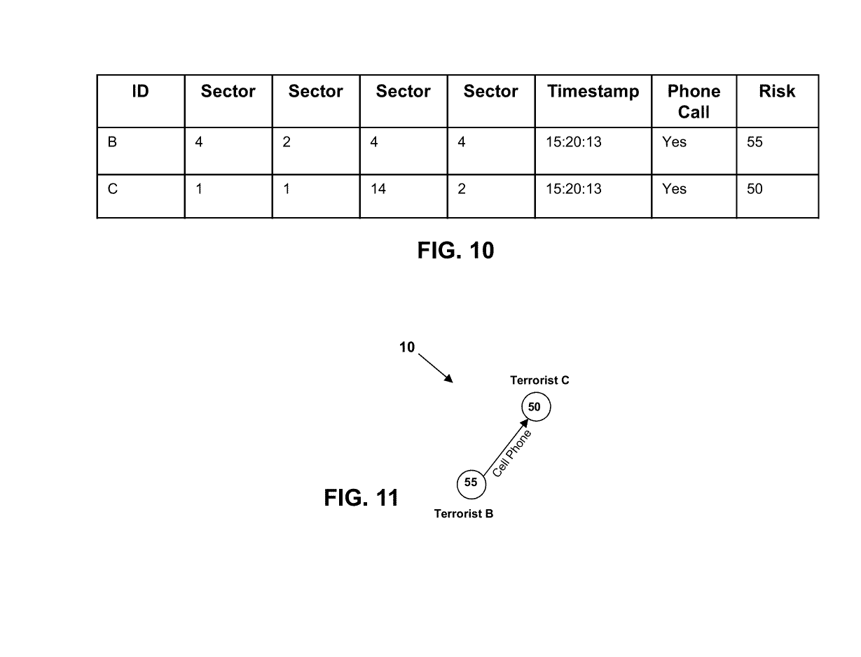

As depicted in FIG. 10, a cell phone used by Terrorist B was used to make a phone call to Terrorist C at 15:20:13. To this extent, Terrorist C can be considered to be a first line connection (i.e., direct connection) to Terrorist B, based on the phone call between Terrorists B and C. Accordingly, the risk assessment score of Terrorist B has increased from 45 to 55, while the risk assessment score of Terrorist C has increased from 40 to 50. A model 10 illustrating the connection between Terrorists B and C is shown in FIG. 11.

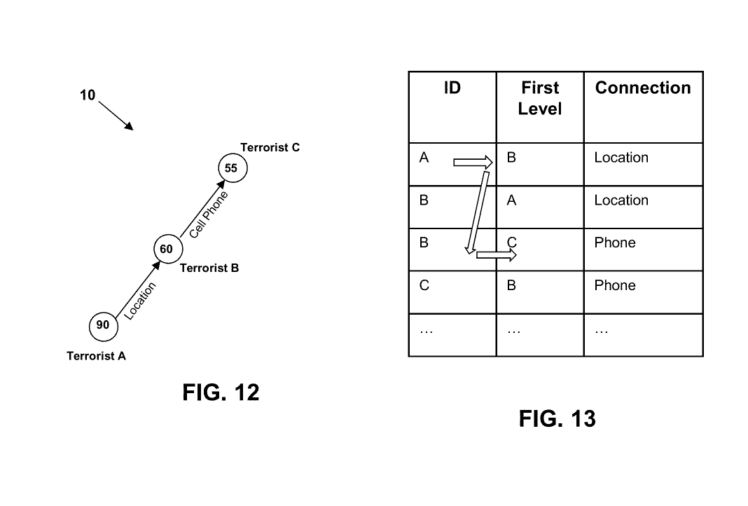

Combining the data in FIGS. 8 and 10, it is apparent that Terrorist C is a second line connection to Terrorist A, based on Terrorist C's direct connection to Terrorist B. To this extent, the risk assessment score of Terrorist A has increased from 70 to 90, the risk assessment score of Terrorist B has increased from 55 to 60, while the risk assessment score of Terrorist C has increased from 50 to 55. A model 10 illustrating the connection between Terrorists A, B, and C is shown in FIG. 12. Because of the connections between Terrorists A, B, and C, it is probable that these terrorists belong to the same terrorist cell or are working together in some way. Additional members of such a terrorist cell may be identified by determining other first, second, third, etc., line connections for each of the terrorists. Conversely, a suspected terrorist may be cleared of any terrorist involvement if the person's model does not include any terrorist related connections.

In this example, Terrorist A's risk assessment score is now higher than a predetermined threshold, indicating, for example, a high terror risk. As a result, emails may be automatically and immediately sent out, posts may be automatically and immediately posted to shared agency sites, and other communications may be automatically and immediately issued. Once someone crosses the predetermined threshold, the status of that person becomes urgent. Terrorist A may be placed on one or more terrorist watch lists (if he/she was not already included) or Terrorist A's information can be updated on one or more terrorist watch lists. Data regarding one or more levels of Terrorist A's connections may also be added to (or updated in) one or more terrorist watch lists.

As described above, the data regarding each first line (direct) connection may be stored to a many-to-many database table. An example of a many-to-many database table in the terrorist scenario is shown in FIG. 13. The many-to-many database table may be converted into a data cube to determine second, third, and additional lines of connections. In the terrorist scenario, such a data cube would show that Terrorist C is a second line connection to Terrorist A as indicated by the flow of arrows in FIG. 13. This would automatically elevate the risk assessment for Terrorists A, B, and C as previously described with regard to FIG. 12.

Such a many-to-many database table also helps determine what filters to apply to incoming data (e.g., telecommunication data records, social media information, historical data, etc.). For example, incoming data can be screened based on the IDs in the many-to-many database table to obtain information specific to each of the listed terrorists.

Numerous factors may determine how much the risk assessment score may be adjusted. For example, the risk assessment score may be increased by different amounts for any of the following: frequency of past meetings; how many people with risk assessment scores are gathered together; repeat visits to the same location; was it a phone call or a location intersection; number of phone calls between parties; frequency of communication (e.g., via cell phone, email, text); number of common websites visited; and/or the like. Numerous other factors are also possible.

It should be noted that risk assessment can also be indicated using non-numerical schemes. For example, natural language output can be provided such as “suspected meeting with XXXX on 05/03/13,” or “risk level elevated due to . . . ” This type of natural language output can be provided to multiple agencies (e.g., posted on inter-agency websites via an http request, xml feed, or API) to facilitate inter-agency sharing.

A large amount of data may be collected for each connection in the model 10. In practice, much of this data is not relevant and may be weeded out using appropriate data filtering. For example, if a person has the same job as a person of interest, that person may often be collocated with the person of interest. This data may not provide any useful information and may be filtered out.

As described above, the model 10 can be provided, for example, using IBM's SPSS predictive analytics software, weighting of relationship distances, a series of SQL queries, heuristic algorithms, Bayesian statistical models, neural networks, or more advanced mathematical models such as k-NN (k-nearest neighbor algorithms). Using such algorithms, the model 10 can be used to determine who may have been (or is) involved in an activity. In addition, the model 10 can be used to establish connections between seemingly unrelated individuals and to predict possible future actions between and/or involving these and other individuals. Stimuli may be introduced into the model 10 (e.g., during the mapping, after the mapping has been completed, or at other times) to determine possible outcomes or to validate a hypothesis or the occurrence of a future activity. For example, what would be the outcome if suspect X is prevented from performing a future action A? What would happen if we assume that suspect X's activities are related in some way to suspect Y's activities? What would happen if suspect Y is prevented from meeting suspect Z? What would happen if suspect X is removed from the model? What would happen if we assumed that suspect X is involved in a criminal activity? An endless number of stimuli are possible. Stimuli may also be used preemptively, where multiple events or actions are taken to reduce the number of possible outcomes, forcing the decision tree to be narrower and reducing the possible outcomes. Certain people and/or events may also be eliminated based on historical data (e.g., both correct guesses and incorrect guesses). Historical data may also be used to narrow the decision tree.

The model 10 of the present invention may be displayed to a user as it is created and updated. This allows the user to visualize the creation and evolution of the model 10 as events, weighting, and/or other data are added or applied to the model. Different data cube relationships can be visualized, for example, by spinning the data cube to view different sets (or cells) of contacts or people in represented in the model 10.

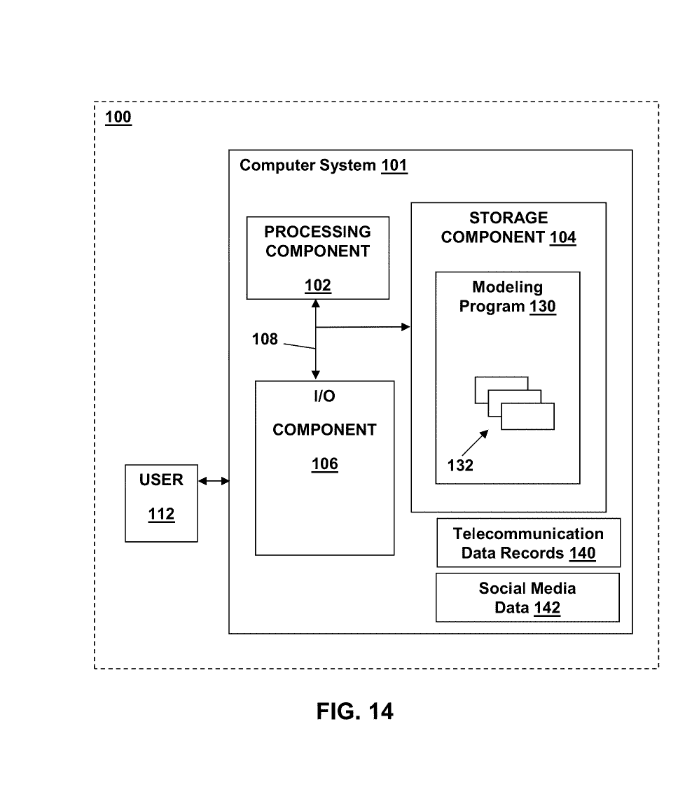

An illustrative environment 100 for detecting illegal activity through interpersonal relationship resolution is shown in FIG. 14. The environment 100 includes at least one computer system 101 and a modeling program 130 that can perform processes described herein in order to detect illegal activity through interpersonal relationship resolution.

The computer system 101 is shown including a processing component 102 (e.g., one or more processors), a storage component 104 (e.g., a storage hierarchy), an input/output (I/O) component 106 (e.g., one or more I/O interfaces and/or devices), and a communications pathway 108. In general, the processing component 102 executes program code, such as the modeling program 130, which is at least partially fixed in the storage component 104. While executing program code, the processing component 102 can process data, such as telecommunication data records 140, social network data 142, and/or the like, which can result in reading and/or writing transformed data from/to the storage component 104 and/or the I/O component 106 for further processing. The pathway 108 provides a communications link between each of the components in the computer system 101. The I/O component 106 can include one or more human I/O devices, which enable a human user 112 to interact with the computer system 101 and/or one or more communications devices to enable a system user 112 to communicate with the computer system 101 using any type of communications link. To this extent, the modeling program 130 can manage a set of interfaces (e.g., graphical user interface(s), application program interfaces, and/or the like) that enable human and/or system users 112 to interact with the modeling program 130. Furthermore, the modeling program 130 can manage (e.g., store, retrieve, create, manipulate, organize, present, etc.) the data, such as the telecommunication data records 140, social media data 142 and/or the like, using any solution.

The computer system 101 can include one or more general purpose computing articles of manufacture (e.g., computing devices) capable of executing program code, such as the modeling program 130, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, the modeling program 130 can be embodied as any combination of system software and/or application software.

Furthermore, the modeling program 130 can be implemented using a set of modules 132. In this case, a module 132 can enable the computer system 20 to perform a set of tasks used by the modeling program 130, and can be separately developed and/or implemented apart from other portions of the modeling program 130. As used herein, the term “component” means any configuration of hardware, with or without software, which implements the functionality described in conjunction therewith using any solution, while the term “module” means program code that enables a computer system 101 to implement the actions described in conjunction therewith using any solution. When fixed in a storage component 104 of a computer system 101 that includes a processing component 102, a module is a portion of a component that implements the actions. Regardless, it is understood that two or more components, modules, and/or systems may share some/all of their respective hardware and/or software. Furthermore, it is understood that some of the functionality discussed herein may not be implemented or additional functionality may be included as part of the computer system 101.

When the computer system 101 includes multiple computing devices, each computing device can have only a portion of the modeling program 130 fixed thereon (e.g., one or more modules 132). However, it is understood that the computer system 101 and the modeling program 130 are only representative of various possible equivalent computer systems that may perform a process described herein. To this extent, in other embodiments, the functionality provided by the computer system 101 and the modeling program 130 can be at least partially implemented by one or more computing devices that include any combination of general and/or specific purpose hardware with or without program code. In each embodiment, the hardware and program code, if included, can be created using standard engineering and programming techniques, respectively.

When the computer system 101 includes multiple computing devices, the computing devices can communicate over any type of communications link. Furthermore, while performing a process described herein, the computer system 101 can communicate with one or more other computer systems using any type of communications link. In either case, the communications link can include any combination of various types of optical fiber, wired, and/or wireless links; include any combination of one or more types of networks; and/or utilize any combination of various types of transmission techniques and protocols.

While shown and described herein as a method and system for detecting illegal activity through interpersonal relationship resolution, it is understood that aspects of the invention further provide various alternative embodiments. For example, in one embodiment, the invention provides a computer program fixed in at least one computer-readable storage medium, which when executed, enables a computer system to for detect illegal activity through interpersonal relationship resolution. To this extent, the computer-readable storage medium includes program code, such as the modeling program 130, which enables a computer system to implement some or all of a process described herein. It is understood that the term “computer-readable storage medium” includes one or more of any type of tangible medium of expression, now known or later developed, from which a copy of the program code can be perceived, reproduced, or otherwise communicated by a computing device. For example, the computer-readable medium can include: one or more portable storage articles of manufacture; one or more memory/storage components of a computing device; paper; and/or the like.

Another embodiment of the invention provides a method of providing a copy of program code, such as the modeling program 30, which enables a computer system to implement some or all of a process described herein. In this case, a computer system can process a copy of the program code to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of the program code, which includes a computer system receiving the set of data signals described herein, and translating the set of data signals into a copy of the computer program fixed in at least one computer-readable medium. In either case, the set of data signals can be transmitted/received using any type of communications link.

Still another embodiment of the invention provides a method for detecting illegal activity through interpersonal relationship resolution. In this case, a computer system, such as the computer system 101, can be obtained (e.g., created, maintained, made available, etc.) and one or more components for performing process(es) described herein can be obtained (e.g., created, purchased, used, modified, etc.) and deployed to the computer system. To this extent, the deployment can include one or more of: (1) installing program code on a computing device; (2) adding one or more computing and/or I/O devices to the computer system; (3) incorporating and/or modifying the computer system to enable it to perform a process described herein; and/or the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

1. A computer-implemented method of detecting a possible occurrence of an illegal activity through interpersonal relationship resolution, the method comprising:
performing actions with at least one computer device, the actions including:
assigning a risk assessment score to a person of interest;
identifying and mapping at least one first line connection of the person of interest;
assigning a risk assessment score to each first line connection;
updating the risk assessment score assigned to the person of interest based on the risk assessment score assigned to each first line connection and a location proximity between the person of interest and each first line connection;
comparing the risk assessment score of the person of interest to at least one threshold value;
detecting a possible occurrence of an illegal activity based on the comparing of the risk assessment score of the person of interest to the at least one threshold value;
identifying and mapping at least one second line connection of the person of interest;
assigning a risk assessment score to each second line connection;
updating the risk assessment score assigned to the person of interest and updating the risk assessment score assigned to each first line connection based on the risk assessment score assigned to each second line connection, a location proximity between the person of interest and each second line connection, and a location proximity between a first line connection and a second line connection;
comparing the updated risk assessment score of the person of interest and comparing the updated risk assessment score of each first line connection to the at least one threshold value;
comparing the risk assessment score of each second line connection to the at least one threshold value, and
detecting a possible occurrence of an illegal activity jointly involving the person of interest and one or more of the first line connections and/or one or more of the second line connections based on the comparing of the updated risk assessment score of the person of interest to the at least one threshold value, the comparing of the updated risk assessment score of each first line connection to the at least one threshold value, and the comparing the risk assessment score of each second line connection to the at least one threshold value.

2. The method of claim 1, wherein each of the detecting steps further comprises:
generating an alert indicating a possible occurrence of an illegal activity.

3-4. (canceled)

5. The method of claim 1, wherein the identifying of the at least one first line connection further comprises:
establishing an entity relationship between the person of interest and each first line connection based on at least one of social network data, telecommunication data records, or historical data.

6. The method of claim 1, further comprising:
assigning a weight to each first line connection; and
updating the risk assessment score assigned to the person of interest based on the risk assessment score and the weight assigned to each first line connection.

7. The method of claim 1, wherein the illegal activity has already occurred.

8. The method of claim 1, wherein the detecting further comprises:
predicting the illegal activity.

9. The method of claim 1, wherein the illegal activity comprises a terrorist activity.

10. The method of claim 1, further comprising:
introducing a stimulus to determine an effect of the stimuli on the mapping.

11. A computer system comprising:
a set of computing devices for detecting a possibility of an illegal activity through interpersonal relationship resolution by performing a method comprising:
assigning a risk assessment score to a person of interest;
identifying and mapping at least one first line connection of the person of interest;
assigning a risk assessment score to each first line connection;
updating the risk assessment score assigned to the person of interest based on the risk assessment score assigned to each first line connection and a location proximity between the person of interest and each first line connection;
comparing the risk assessment score of the person of interest to at least one threshold value;
detecting a possible occurrence of an illegal activity based on the comparing of the risk assessment score of the person of interest to the at least one threshold value;
identifying and mapping at least one second line connection of the person of interest;
assigning a risk assessment score to each second line connection;
updating the risk assessment score assigned to the person of interest and updating the risk assessment score assigned to each first line connection based on the risk assessment score assigned to each second line connection, a location proximity between the person of interest and each second line connection, and a location proximity between a first line connection and a second line connection;
comparing the updated risk assessment score of the person of interest and comparing the updated risk assessment score of each first line connection to the at least one threshold value;
comparing the risk assessment score of each second line connection to the at least one threshold value, and
detecting a possible occurrence of an illegal activity jointly involving the person of interest and one or more of the first line connections and/or one or more of the second line connections based on the comparing of the updated risk assessment score of the person of interest to the at least one threshold value, the comparing of the updated risk assessment score of each first line connection to the at least one threshold value, and the comparing the risk assessment score of each second line connection to the at least one threshold value.

12. A computer program product comprising program code embodied in at least one computer-readable non-transitory storage medium, which when executed, enables a computer system to implement a method of detecting a possibility of an illegal activity through interpersonal relationship resolution, the method comprising:
assigning a risk assessment score to a person of interest;
identifying and mapping at least one first line connection of the person of interest;
assigning a risk assessment score to each first line connection;
updating the risk assessment score assigned to the person of interest based on the risk assessment score assigned to each first line connection and a location proximity between the person of interest and each first line connection;
comparing the risk assessment score of the person of interest to at least one threshold value;
detecting a possible occurrence of an illegal activity based on the comparing of the risk assessment score of the person of interest to the at least one threshold value;
identifying and mapping at least one second line connection of the person of interest;
assigning a risk assessment score to each second line connection;
updating the risk assessment score assigned to the person of interest and updating the risk assessment score assigned to each first line connection based on the risk assessment score assigned to each second line connection, a location proximity between the person of interest and each second line connection, and a location proximity between a first line connection and a second line connection;
comparing the updated risk assessment score of the person of interest and comparing the updated risk assessment score of each first line connection to the at least one threshold value;
comparing the risk assessment score of each second line connection to the at least one threshold value, and
detecting a possible occurrence of an illegal activity jointly involving the person of interest and one or more of the first line connections and/or one or more of the second line connections based on the comparing of the updated risk assessment score of the person of interest to the at least one threshold value, the comparing of the updated risk assessment score of each first line connection to the at least one threshold value, and the comparing the risk assessment score of each second line connection to the at least one threshold value.

13. The program product of claim 12, wherein the detecting further comprises:
generating an alert indicating a possible occurrence of an illegal activity.

14-15. (canceled)

16. The program product of claim 12, wherein the identifying of the at least one first line connection further comprises:
establishing an entity relationship between the person of interest and each first line connection based on at least one of social network data, telecommunication data records, or historical data.

17. The program product of claim 12, the method further comprising:
assigning a weight to each first line connection; and
updating the risk assessment score assigned to the person of interest based on the risk assessment score and the weight assigned to each first line connection.

18. The program product of claim 12, wherein the illegal activity has already occurred.

19. The program product of claim 12, wherein the detecting further comprises:
predicting the illegal activity.

20. The program product of claim 12, the method further comprising:
introducing a stimulus to determine an effect of the stimuli on the mapping.

21. The method of claim 1, wherein one of the location proximity between the person of interest and each first line connection, the location proximity between the person of interest and each second line connection, and the location proximity between a first line connection and a second line connection is gathered from cell phone sector information.

22. The method of claim 21, wherein the cell phone sector information is gathered in real time.

23. The computer system of claim 11, wherein one of the location proximity between the person of interest and each first line connection, the location proximity between the person of interest and each second line connection, and the location proximity between a first line connection and a second line connection is gathered from cell phone sector information.

24. The computer program product of claim 12, wherein one of the location proximity between the person of interest and each first line connection, the location proximity between the person of interest and each second line connection, and the location proximity between a first line connection and a second line connection is gathered from cell phone sector information.
